(19) United States
(12) Patent Application Publication
(10) Pub. No.: US 2019/0285389 A1
(43) Pub. Date: Sep. 19, 2019

(54) DEVICE FOR LOCATING AN IMPACT AGAINST AN INTERACTIVE SURFACE, CORRESPONDING METHOD AND COMPUTER PROGRAM

(71) Applicant: COMMISSARIAT A L'ENERGIE ATOMIQUE ET AUX ENERGIES ALTERNATIVES, Paris (FR)

(72) Inventors: Jean-Marc ALEXANDRE, Verrieres-le-Buisson (FR); Robert BODEN, Dourdan (FR)

(73) Assignee: COMMISSARIAT A L'ENERGIE ATOMIQUE ET AUX ENERGIES ALTERNATIVES, Paris (FR)

(21) Appl. No.: 16/340,574

(22) PCT Filed: Oct. 6, 2017
(86) PCT No.: PCT/FR2017/052744

§ 371 Date: Apr. 9, 2019

(30) Foreign Application Priority Data
Oct. 10, 2016 (FR) 1659741

(51) Int. Cl. F41J 5/056; G06F 3/041

(52) U.S. Cl. CPC F41J 5/056; G06F 3/04144

(57) ABSTRACT

A device for locating an impact against an interactive surface comprises M transducers distributed against the interactive surface, M≥4, and an electronic central unit programmed to locate the impact by analysing time differences of propagation of progressive mechanical waves from the impact to the transducers on the basis of instants of impact detection identified in the electrical signals supplied by the transducers. The electronic central unit is programmed to select, among the M transducers, a subset of N transducers, 3≤N<M, of which the electrical signals chronologically comprise the first N instants of detection of impact identified and to locate the impact based on these N first instants of detection of impact identified and on the places of arrangement in the interactive surface of the N transducers selected.

This invention relates to a device for locating an impact against an interactive surface, by analysing time differences of the propagation of progressive mechanical waves propagating from the impact. It also relates to a method implemented by this device and a corresponding computer program.

Many objects with an interactive surface are known, in particular display devices, mobile telephones or other mobile personal digital assistance devices. Their interface is in general a flat and rectangular screen with which a user can interact using a projectile, a stylus or even a finger. Note however that the invention applies more generally to any type of object that has an interactive surface that can propagate progressive mechanical waves from an impact, this surface not necessarily being flat, or with a rectangular contour.

The term interactive surface means a two-dimensional or three-dimensional surface, capable of changing shape in the sense of the dynamic and static elasticity of the materials when it is subjected to an impact such as a touch, a force of contact, a mechanical pulse or an impact, by thus allowing the propagation of progressive mechanical waves that can be detected using transducers, in particular surface acoustic waves, from the location of the impact. The surface deformation can be submillimetric that cannot be perceived by the unaided eye. Surfaces made from plastic, glass or metal are suitable.

Each one of the known objects with an interactive surface comprises a device for locating impacts using one or several detection techniques. A strong trend in the reduction of the manufacturing cost and in the reduction of the size aims to retain only the simplest technologies that use a limited number of sensors. The invention thus relates more precisely to a device for locating that implements a technology for detecting the propagation of progressive mechanical waves in an interactive surface, in particular using detectors of the piezoelectric transducer type.

A first solution is disclosed in patent U.S. Pat. No. 7,345,677 B2. It is based on the recognition of the position of an impact by learning. The method implemented uses a cross-correlation between at least one measured acoustic signal from the detection of an acoustic wave generated by an impact on the interactive surface of the object and a reference set referred to as “a signature set” formed from pre-recorded pulse acoustic responses, with each one relating to a predefined position that is sought to be associated with a function and recognised when an impact is carried on this position.

A second solution, for example disclosed in patent U.S. Pat. No. 8,330,744 B2, consists in measuring the disturbance of an impact on the propagation of progressive mechanical waves emitted regularly in the interactive surface independently of this impact. This solution is considered to be more precise and reliable than the preceding one, in particular in order to qualify or follow the impact, but it is also based on a recognition of the position of an impact by learning.

These first two solutions have the disadvantage of depending on this learning which can be both complex to implement and quickly unusable in case of variations in the medium or in the interactive surface. They furthermore require rather substantial computing power.

A third, older solution is based on the measurement of a difference in transit time of a wave packet generated by an impact to a plurality of piezoelectric detectors and on the deterministic calculation, using a pre-established mathematical formula, of the position of an emitting source of the wave packet. Thus, this solution requires a device for locating an impact that comprises:
at least three transducers arranged and distributed against the interactive surface, designed to capture the progressive mechanical waves propagating in the interactive surface and to transform them into electrical signals, and
an electronic central unit, connected to the transducers in order to receive their electrical signals, programmed to locate the impact in the interactive surface by analysing time differences of propagation of progressive mechanical waves from the impact to the transducers on the basis of instants of impact detection identified in the electrical signals received.

Generally, it is as such possible to locate a one-off impact of a finger or object (for example a projectile or a stylus), since the latter is then an emitter of a pulse. But with this rather old technology, however advantageously simple, it is difficult to reach good precision in locating beyond certain dimensions of the interactive surface because the progressive mechanical waves have the particularity of attenuating very quickly.

For example, for an interactive surface made of polycarbonate, an impact of 1 joule generates on a transducer located more than 50 cm a signal that is already too weak to be able to be used. Consequently, this solution, for example chosen in patents U.S. Pat. Nos. 6,933,930 B2 and 6,367,800 B1, applies to interactive surfaces with small dimensions with respect to the force of the impacts that they are supposed to detect and locate.

It can thus be sought to design a device for locating an impact that makes it possible to overcome at least one portion of the aforementioned problems and constraints.

A device for locating an impact against an interactive surface able to propagate progressive mechanical waves from the impact is therefore proposed, comprising:
a set of M transducers arranged and distributed against the interactive surface, M≥4, designed to capture the progressive mechanical waves propagating in the interactive surface and to transform them into electrical signals, and
an electronic central unit, connected to the transducers in order to receive their electrical signals, programmed to locate the impact in the interactive surface by analysing time differences of propagation of progressive mechanical waves from the impact to the transducers on the basis of instants of impact detection identified in the electrical signals received,
   wherein the electronic central unit is programmed to:
select, from the M transducers, a subset of N transducers, 3≤N<M, of which the electrical signals chronologically comprise the first P instants of detection of impact identified, and
locate the impact based on these N first instants of detection of impact identified and on the places of arrangement in the interactive surface of the N transducers selected.

Thus, while locating the impact using a reduced number N of transducers which can be deemed as necessary for carrying out the processing, it is possible to increase at will the total number M of transducers arranged against the interactive surface according to its size in order to ensure an enlarged sensitivity without however increasing the complexity of the calculations. The ingenuity of this invention consists in varying the N transducers of which the signals will in the end be used for locating according to the position of the impact: these are concretely the N transducers that are closest to the impact.

Optionally, the M transducers are distributed in a regular two-dimensional manner into a matrix of transducers against the interactive surface and the electronic central unit is programmed to select N=4, 6 or 9 transducers among these M transducers.

Also optionally, the M transducers are distributed in a regular two-dimensional manner staggered against the interactive surface and the electronic central unit is programmed to select N=3, 4 or 7 transducers among these M transducers.

Also optionally:
the M transducers are electrically connected together into several separate groups which are themselves electrically connected to the electronic central unit,
at least three additional transducers are arranged and distributed against the interactive surface, designed to capture the progressive mechanical waves propagating in the interactive surface and to transform them into electrical signals transmitted independently to the electronic central unit, and
the electronic central unit is programmed to pre-locate the impact in the interactive surface based on the electrical signals received from the additional transducers and to select the subset of N transducers based on this pre-locating.

Also optionally:
the M transducers are electrically connected together into four separate groups which are themselves electrically connected to the electronic central unit, in such a way that any four neighbouring transducers of the same basic cell of the matrix of transducers always belong respectively to the four separate groups, and
four additional transducers are arranged and distributed against the interactive surface.

Also optionally:
the M transducers are electrically connected together into nine separate groups which are themselves electrically connected to the electronic central unit, in such a way that any nine neighbouring transducers forming four adjacent basic cells having the same common central transducer of the matrix of transducers always belong respectively to the nine separate groups, and
four additional transducers are arranged and distributed against the interactive surface.

Also optionally:
the M transducers are electrically connected together into three separate groups which are themselves electrically connected to the electronic central unit, and
three additional transducers are arranged and distributed against the interactive surface.

Also optionally:
the M transducers are electrically connected together into six separate groups which are themselves electrically connected to the electronic central unit, in such a way that any three neighbouring transducers of the same basic triangular cell of the matrix of transducers always belong respectively to three separate groups, and
three additional transducers are arranged and distributed against the interactive surface.

A method for locating an impact against an interactive surface able to propagate progressive mechanical waves from the impact is also proposed, comprising the following steps:
capturing, using a set of M transducers arranged and distributed against the interactive surface, M≥4, the progressive mechanical waves propagating in the interactive surface and transforming them into electrical signals, and
locating the impact in the interactive surface, using an electronic central unit connected to the transducers in order to receive their electrical signals, by analysing time differences of propagation of progressive mechanical waves from the impact to the transducers on the basis of instants of impact detection identified in the electrical signals received,
   the locating of the impact comprising the following steps:
selecting, from the M transducers, a subset of N transducers, 3≤N<M, of which the electrical signals chronologically comprise the first N instants of detection of impact identified, and
locating the impact based on these N first instants of detection of impact identified and on the places of arrangement in the interactive surface of the N transducers selected.

A computer program that can be downloaded from a communication network and/or recorded on a support that can be read by a computer and/or executed by a processor is also proposed, comprising instructions for the execution of the steps of a method for locating an impact according to the invention, when said program is executed on a computer.

The invention shall be better understood using the following description, provided solely as an example and in reference to the accompany drawings wherein:

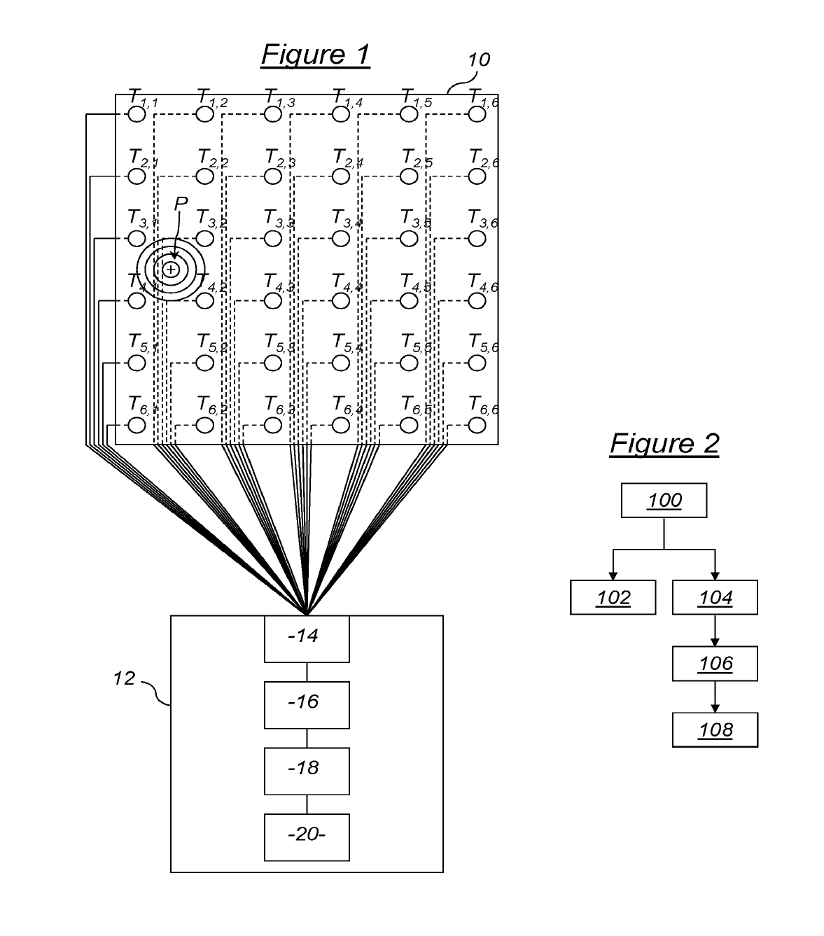

FIG. 1 diagrammatically shows the general structure of a device for locating an impact according to a first alternative of a first embodiment of the invention,

FIG. 2 shows the successive steps of a method for locating an impact according to an embodiment of the invention,

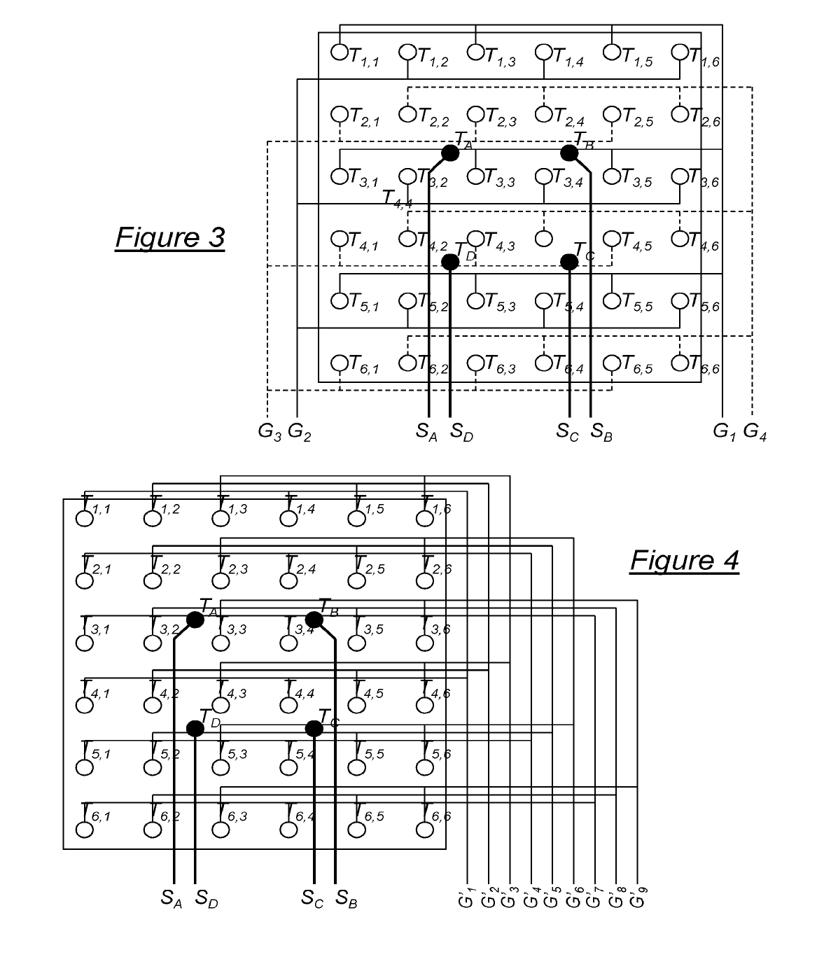

FIGS. 3 and 4 diagrammatically and partially show two other alternatives of the first embodiment of a device for locating an impact according to the invention, and

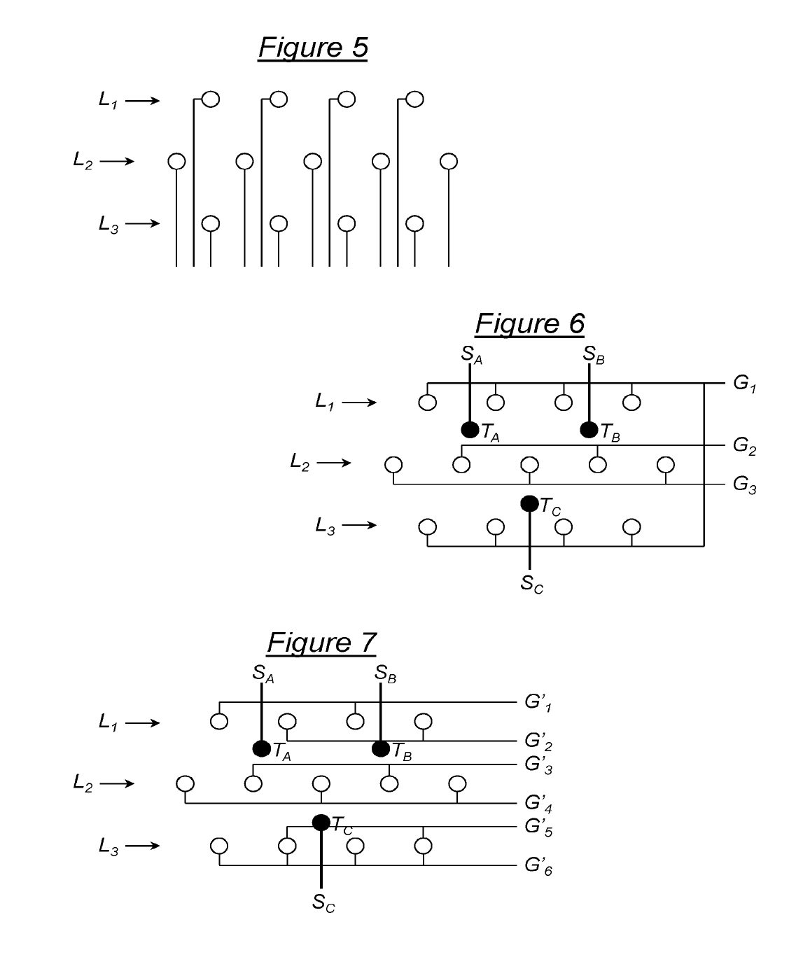

FIGS. 5 to 7 diagrammatically and partially show three alternatives of a device for locating an impact according to a second embodiment of the invention.

The facility shown diagrammatically in FIG. 1 according to a first embodiment of the invention comprises a rectangular interactive surface 10, that can propagate progressive mechanical waves from an impact P, and a device for locating any impact against this interactive surface 10. The latter is for example an impactile screen made from polycarbonate or other material suitable whereon is projected, either via the front, or via the rear by using a rear projection sheet, an image or a video, for example using a projector.

The device for locating comprises:
a set of M transducers, for example piezoelectric sensors, arranged and distributed against the interactive surface 10, with M≥4, designed to capture the progressive mechanical waves propagating in the interactive surface 10 and to transform them into electrical signals, and
an electronic central unit 12, connected to the M transducers in order to receive their electrical signals, programmed to locate the impact P in the interactive surface 10 by analysing time differences of propagation of progressive mechanical waves from the impact P to the M transducers on the basis of instants of impact P detection identified in the electrical signals received.

Note that, in general, the interactive surface 10 is of any shape, not necessarily rectangular. The number of transducers is also indifferent, at least equal to four in order to allow an implementation of the invention. They are advantageously arranged against the rear face of the interactive surface 10 in such a way as to not hinder an image or video that may be projected onto the front face thereof.

In the embodiment of FIG. 1, the M transducers are distributed in a two-dimensional manner into a matrix of transducers against the interactive surface 10. This matrix comprises any number ML≥2 of lines, any number MC≥2 of columns and is noted as (T_{i,j}), with the M=ML×MC transducers being noted as with T_{i,j} with 1≤i≤ML and 1≤j≤MC. As a non-limiting example, ML=MC=6 for the matrix of FIG. 1 which then comprises thirty-six transducers T_{1,1}, . . . , T_{i,j}, . . . , T_{6,6}.

The electronic central unit 12 comprises more precisely an interface 14 for receiving thirty-six electrical signals supplied independently for each one of the thirty-six transducers T_{1,1}, . . . , T_{i,j}, . . . , T_{6,6}. This interface 14 can comprise an analogue amplifier.

The electronic central unit 12 further comprises a module 16 for identifying the instants of detection of impact P in the electrical signals received. Details on the operation of this module will not be provided, knowing that such an identification is well known to those skilled in the art, such as for example taught in document U.S. Pat. Nos. 6,933,930 B2 or 6,367,800 B1. It can be analogue and/or digital, therefore at least in part programmed. According to the dimensions of the interactive plate 10 and of the power of the impact P, it may be that the instants of detection of the impact P cannot be identified in all of the signals received, in particular in those received from the transducers the furthest away since they are then too weak. But in the framework of this invention, this apparent problem is cleverly resolved from the moment when these instants can be identified in at least the closest N transducers, such as shall now be explained.

The electronic central unit 12 comprises indeed a selector 18 designed and/or programmed to select, from the M transducers, a subset of N transducers, with 3≤N<M, of which the electrical signals chronologically comprise the first N instants of detection of impact identified. In light of the propagation properties used, these N selected electrical signals come from the N transducers that are the closest to the impact P. N is greater than or equal to 3 because it is theoretically the number required and sufficient of transducers in order to be able to determine a location of the impact P in the interactive surface 10 according to the teaching of U.S. Pat. Nos. 6,933,930 B2 or 6,367,800 B1. In a matrix arrangement of the transducers as shown in FIG. 1, it is relevant to choose N=4, 6 or 9, according to whether the impact P is located between four neighbouring transducers forming a basic cell {T_{i,j}, T_{i,j+1}, T_{i+1, j}, T_{i+1, j+1}} of the matrix (T_{i,j}) (this is for example the case of the impact P shown that is located between the transducers T_{3,1}, T_{3,2}, T_{4,1} and T_{4,2}), in the vicinity of a line or column of the matrix between two neighbouring transducers {T_{i,j}, T_{i,j+1}} or {T_{i,j}, T_{i+1,j}}, or in the vicinity of a transducer T_{i,j} of the matrix. The redundancy of the instants of detection of impact identified are then used in order to optimise the estimating of the location of the impact P by maximum likelihood for example. The selector 18 can be analogue and/or digital, therefore at least in part programmed.

The electronic central unit 12 finally comprises a calculator 20 programmed to calculate an estimation of the location of the impact P using instants of detection of impact identified in the N signals selected and the places of arrangement of the N corresponding transducers in the interactive surface 10. Details on the operation of this calculator 20 will not be provided, knowing that such an estimation is well known to those skilled in the art, such as for example taught in document U.S. Pat. Nos. 6,933,930 B2 or 6,367,800 B1.

Note that the aforementioned various programmed elements in the module for identifying 16, the selector 18 and the calculator 20 may form only one, the distinction being purely functional. They can have the form of one or several microprocessors programmed to carry out a certain number of functions that can be implemented using computer programs, i.e. in the form of a computer device. But these functions could also be at least partially micro programmed or micro wired in dedicated integrated circuits. Thus, alternatively, the computer device implementing the aforementioned elements could be replaced with an electronic device comprised solely of digital circuits (without a computer program) for the carrying out of the same functions.

A method for locating an impact implemented by the electronic central unit 12 shall now be detailed in reference to FIG. 2.

At an initial instant, during a first step 100, an impact P generates progressive mechanical waves intended to propagate in all of the directions in the interactive surface 10.

Starting from this initial instant, during a step 102, the thirty-six transducers T_{1,1}, . . . , T_{i,j}, . . . , T_{6,6} capture these progressive mechanical waves and transform them into electrical signals.

In parallel to this step 102, during steps 104, 106, 108, the electronic central unit 12 receives the electronic signals supplied by the transducers T_{1,1}, . . . , T_{i,j}, . . . , T_{6,6} and its module for identifying 16, its selector 18 as well as its calculator 20 process them in order to locate the impact P in the interactive surface 10 by analysing time differences of propagation of these progressive mechanical waves from the impact P to the N=4, 6 or 9 transducers that are closest to the impact P.

More precisely, during the step 104, the module for identifying 16 identifies the instants of detection of impact in at least one portion of the electrical signals received by the electronic central unit 12. Some of the signals can be too weak for such an identification to be able to be carried out, but this has no importance starting from the moment when at least N instants of detection of impact are identified in at least N electrical receives received.

Then, during the step 106, the selector 18 selects the N=4, 6 or 9 transducers that are closest to the impact P, i.e. those of which the electrical signals chronologically comprise the N first instants of detection of impact identified. In particular, if the first four instants of detection of impact identified are clearly from four neighbouring transducers forming a basic cell {T_{i,j}, T_{i,j+1}, T_{i+1,j}, T_{i+1,j+1}} of the matrix of transducers, then this means that the impact P is located between these four transducers and the selection of these N=4 transducers is sufficient to carry out an optimum location of the impact P. If the first four instants of detection of impact identified seem to come from six neighbouring transducers forming two adjacent basic cells of the matrix of transducers, to the nearest margin of tolerance, then this means that the impact P is located in the vicinity of a line or column of the matrix between two neighbouring transducers {T_{i,j}, T_{i,j+1}} or {T_{i,j}, T_{i+1,j}} and the selection of the N=6 transducers of these two adjacent basic cells is sufficient to carry out an optimum locating of the impact P. Finally, if the four first instants of detection of impact identified seem to come from nine neighbouring transducers {T_{i,j}, T_{i,j+1}, T_{i,j+2}, T_{i+1,j}, T_{i+1,j+1}, T_{i+1, j+2}, T_{i+2,j}, T_{i+2,j+1}, T_{i+2,j+2}} forming four adjacent basic cells of the matrix of transducers, to the nearest margin of tolerance, then this means that the impact P is located in the vicinity of the transducer T_{i+1,j+1} located at the centre of these four adjacent basic cells and the selection of the N=9 transducers forming these four basic cells is sufficient for carrying out an optimum locating of the impact P.

Then, during the step 108, the calculator 20 determines as indicated hereinabove the location of the impact P, for example as Cartesian coordinates in the interactive surface 10, on the basis of the N instants of impact detection P identified in the N electrical signals received and selected and of the respective locations of the N corresponding transducers. This calculation can include the optimisation of a likelihood criterion, in particular when several adjacent basic cells are solicited. The method is then ready for the detection of another impact (return to step 100).

Alternatively, the step of calculating 108 could be executed before the step of selecting 106. Each basic cell {T_{i,j}, T_{i,j+1}, T_{i+1,j}T_{i+1,j+1}} of four neighbouring transducers can independently be considered by the electronic central unit 12 during the step 108 in order to carry out, using the calculator 20, an estimation of the location of an impact using instants of detection of impact identified in this basic cell and of the locations of its four transducers. Then, the selecting 106 can be done on the location, the two locations or the four locations based respectively on the N=4, 6 or 9 first instants of detection of impact identified.

Note that the calculator 20 can also be configured to measure an impact energy P in addition to its location.

In light of the pulse shape of the signals emitted by the transducers in case of the detection of impact and of the strong potential attenuation of the waves at the origin of these signals in the interactive surface 10 according to the distance with respect to the impact P, the correct distance between two neighbouring transducers in line or column of the matrix of transducers is to be determined so that the spatial width of the pulse is clearly less than this distance, but so that the attenuation is also not too strong over this distance. This compromise is within the scope of those skilled in the art. For example, for an interactive surface made of polycarbonate intended to receive shooting projectiles, arrows or darts that can reach several tens of joules, the transducers can advantageously be separated by 50 cm +/−10% in lines and columns. It is thus possible to increase at will the size of the interactive surface 10, until having a wall of image(s) by multiplying the transducers, without however increasing the complexity of the locating of impacts.

A disadvantage of the implementation alternative of the embodiment of FIG. 1 is the complexity of the cabling since, for a matrix of thirty-six transducers, thirty-six independent connectors to the electronic central unit 12 are required. A simplification of the cabling can therefore be proposed in a second implementation alternative shown in FIG. 3.

According to this second alternative, the thirty-six transducers T_{1,1}, . . . , T_{i,j}, . . . , T_{6,6} are electrically connected together into several separate groups which are themselves electrically connected to the electronic central unit 12. A first group G₁ of nine transducers connected together concerns the transducers identified by a reference T_{1+2i,1+2j} in the matrix of transducers, where i and j are positive or zero subscript integers. A second group G₂ of nine transducers connected together concerns the transducers identified by a reference T_{1+2i,2+2j} in the matrix of transducers. A third group G₃ of nine transducers connected together concerns the transducers identified by a reference T_{2+2i,1+2j} in the matrix of transducers. A fourth group G₄ of nine transducers connected together concerns the transducers identified by a reference T_{2+2i,2+2j} in the matrix of transducers. Thus, all of the transducers of the matrix (T_{i,j}) are connected to one of these four groups in such a way that only four electrical signals arrive on the interface 14 of the electronic central unit 12. Note that these connections are carried out in such a way that any four neighbouring transducers of the same basic cell {T_{i,j}, T_{i,j+1}, T_{i+1,j}, T_{i+1,j+1}} of the matrix (T_{i,j}) of transducers always belong respectively to the four separate groups G₁, G₂, G₃ and G₄.

This results in an ambiguity in the instants of detection of impacts identified since it is then no longer possible to know exactly to which transducer corresponds such and such an instant identified in one of the four signals received by the electronic central unit 12. In order to overcome this ambiguity, at least three additional transducers are arranged and distributed against the interactive surface 10, also designed to capture the progressive mechanical waves propagating in the interactive surface 10 and to transform them into electrical signals transmitted independently to the electronic central unit 12. In the alternative implementation of FIG. 3, there are four of them, T_{A}, T_{B}, T_{C} and T_{D}, supplying four different electrical signals S_{A}, S_{B}, S_{C}, S_{D} to the electronic central unit 12. They are advantageously positioned on the diagonals of the interactive surface 10 and at locations that minimise the distance of the possible location of impact that is the farthest away. They do not need to supply a very precise measurement.

Thus, according to this second alternative, the selector 18 is adapted in such a way as to use the signals S_{A}, S_{B}, S_{C}, S_{D} to pre-locate in a manner that is at least approximate manner the impact P in the interactive surface 10 during the step of selecting 106 so as to select on this base a vicinity of N=4, 6 or 9 transducers considered as the closest to this pre-location. The N=4, 6 or 9 instants of detection of impacts identified in the signals provided by the groups G₁, G₂, G₃, G₄ are then assigned to the transducers thus selected for the execution of the calculation of the location carried by the calculator 20 during the step 108.

A disadvantage of the alternative implementation of FIG. 3 appears when the impact P is located in the vicinity of a line or column of the matrix (T_{i,j}) between two neighbouring transducers. In this case, there are at least two other transducers approximately equidistant from the point of impact P that are taken into account in the selection of the step 106 and which are part of the same group G₁, G₂, G₃ or G₄. Their two instants of detection of impact are then confounded into a single one that results from the superposition of two electrical signals that are sufficiently close sot that their pulses are added together. This adding of non-differentiable signals generates an error in the identification of the instant of detection of impact and therefore in the location of the step 108. This error however remains low and entirely acceptable in a certain number of applications for which a great precision is not sought. In the opposite case, an adaptation of the cabling can therefore be proposed in a third alternative implementation shown in FIG. 4.

According to this third alternative, the thirty-six transducers T_{1,1}, . . . , T_{i,j}, . . . , T_{6,6} are electrically connected together into several separate groups which are themselves electrically connected to the electronic central unit 12. A first group G′₁ of four transducers connected together concerns the transducers identified by a reference T_{1+3i,1+3j} in the matrix of transducers, where i and j are positive or zero subscript integers. A second group G′₂ of four transducers connected together concerns the transducers identified by a reference T_{1+3i,2+3j} in the matrix of transducers. A third group G′₃ of four transducers connected together concerns the transducers identified by a reference T_{1+3i,3+3j} in the matrix of transducers. A fourth group G′₄ of four transducers connected together concerns the transducers identified by a reference T_{2+3i,1+3j} in the matrix of transducers. A fifth group G′₅ of four transducers connected together concerns the transducers identified by a reference T_{2+3i,2+3j} in the matrix of transducers. A sixth group G′₆ of four transducers connected together concerns the transducers identified by a reference T_{2+3i,3+3j} in the matrix of transducers. A seventh group G′₇ of four transducers connected together concerns the transducers identified by a reference T_{3+3i,1+3j} in the matrix of transducers. An eighth group G′₈ of four transducers connected together concerns the transducers identified by a reference T_{3+3i,2+3j} in the matrix of transducers. A ninth group G′₉ of four transducers connected together concerns the transducers identified by a reference T_{3+3i,3+3j} in the matrix of transducers. Thus, all of the transducers of the matrix are connected to one of these nine groups in such a way that only nine electrical signals arrive on the interface 14 of the electronic central unit 12. Note that these connections are carried out in such a way that any nine neighbouring transducers {T_{i,j}, T_{i,j+1}, T_{i,j+2}, T_{i+1,j}, T_{i+1,j+1}, T_{i+1,j+2}, T_{i+2,j}, T_{i+2,j+1}, T_{i+2,j+2}} forming four adjacent basic cells having the same common central transducer T_{i+1,j+1} of the matrix (T_{i,j}) of transducers always belong respectively to the nine separate groups.

As hereinabove, in order to overcome the ambiguity in the instants of detection of impacts identified, four additional transducers T_{A}, T_{B}, T_{C} and T_{D} are arranged and distributed against the interactive surface 10, also designed to capture the progressive mechanical waves propagating in the interactive surface 10 and to transform them into electrical signals S_{A}, S_{B}, S_{C}, S_{D} transmitted independently to the electronic central unit 12. They are advantageously positioned on the diagonals of the interactive surface 10 and at locations that minimise the distance of the possible location of impact that is the farthest away. They do not need as hereinabove to supply a very precise measurement.

Also as hereinabove, the selector 18 is adapted in such a way as to use the signals S_{A}, S_{B}, S_{C}, S_{D} to pre-locate at least approximately the impact P in the interactive surface 10 during the step of selecting 106 so as to select on this base a vicinity of N=4, 6 or 9 transducers considered as the closest to this pre-location. The N=4, 6 or 9 instants of detection of impacts identified in the signals provided by the groups G′₁, G′₂, G′₄, G′₅, G′₆, G′₇, G′₈, G′₉ are then assigned to the transducers thus selected for the execution of the calculation of the location carried by the calculator 20 during the step 108.

Note that in this third alternative of FIG. 4, even when the impact P is located in the vicinity of a line or column of the matrix (T_{i,j}), there cannot be two selected transducers that belong to the same group. This improvement with respect to the preceding alternative is then obtained at the price of a greater number of signals provided to the electronic central unit 12, without the latter reaching however that of the first alternative.

According to a first alternative of another possible embodiment shown partially in FIG. 5 (with only three lines L₁, L₂ and L₃ being partially shown), the M transducers can be distributed in a regular two-dimensional manner staggered against the interactive surface 10. In this case, by direct adaptation of the preceding embodiment to the triangular basic cells of this embodiment, the selector 18 of the electronic central unit 12 is advantageously designed and/or programmed to select a subset of N=3, 4 or 7 transducers among the M transducers. Note however that diamond subsets of N=4, 6 or 9 transducers could also be selected in this embodiment, in the same way as triangle subsets of N=3, 4 or 7 transducers could be selected in the first embodiment of FIGS. 1, 3 and 4.

A disadvantage of this first alternative implementation of the second embodiment is the complexity of the cabling since, as in the alternative of FIG. 1, each transducer independently transmits its electrical signal to the electronic central unit 12. A simplification of the cabling can therefore be proposed in a second alternative implementation of the second embodiment shown in FIG. 6.

According to this second alternative, the M transducers are electrically connected together into several separate groups which are themselves electrically connected to the electronic central unit 12. For example all of the transducers of the lines L₁ and L₃ shown in FIG. 6 are connected together between them in a first group G₁ while the transducers of the line L₂, staggered with respect to L₁ and L₃, are alternatively connected to a second group G₂ and to a third group G₃. As in the second alternative of FIG. 3, in order to overcome any ambiguity in the instants of detection of impacts identified, at least three additional transducers are arranged and distributed against the interactive surface 10, also designed to capture the progressive mechanical waves propagating in the interactive surface 10 and to transform them into electrical signals transmitted independently to the electronic central unit 12 for the purpose of a pre-locating for the step of selecting 108. In the alternative implementation of FIG. 6, there are three of them, T_{A}, T_{B} and T_{C}, supplying three different electrical signals S_{A}, S_{B}, S_{C} to the electronic central unit 12.

A disadvantage of this second alternative implementation of the second embodiment is the same as in the second alternative implementation of the first embodiment of FIG. 3 when the impact P is close to an edge (i.e. a segment between any two neighbouring transducers) of the staggered arrangement. If necessary, an adaptation of cabling can be proposed in a third alternative implementation of the second embodiment shown in FIG. 7.

According to this third alternative, the M transducers are electrically connected together into several separate groups which are themselves electrically connected to the electronic central unit 12. For example the transducers of the line L₁ are alternatively connected to a first group G′₁ and to a second group G′₂, the transducers of the line L₂ are alternatively connected to a third group G′₃ and to a fourth group G′₄, the transducers of the line L₃ are alternatively connected to a fifth group G′₅ and to a sixth group G′₆. As in the preceding alternative, in order to overcome any ambiguity in the instants of detection of impacts identified, three additional transducers T_{A}, T_{B} and T_{C} are arranged and distributed against the interactive surface 10, also designed to capture the progressive mechanical waves propagating in the interactive surface 10 and to transform them into electrical signals S_{A}, S_{B}, S_{C} transmitted independently to the electronic central unit 12 for the purpose of a pre-locating for the step of selecting 108.

Note that in this third alternative of FIG. 7, even when the impact P is located close to an edge of the staggered arrangement, there cannot be two selected transducers that belong to the same group. Indeed, the six separate groups are advantageously chosen so that any three neighbouring transducers of the same triangular basic cell of the matrix of transducers always belong respectively to three separate groups. This improvement with respect to the second alternative of FIG. 6 is then obtained at the price of a greater number of signals provided to the electronic central unit 12, without the latter reaching however that of the first alternative of FIG. 5.

It clearly appears that a device for locating an impact such as one of those described hereinabove makes it possible to locate an impact using a reduced number N of transducers in an interactive surface of which the dimensions can be enlarged by arranging a number M>N of transducers, M able to be as large as desired, without however increasing the complexity of the calculations of the location of impact. This makes it possible to consider leisure or other applications for interaction with large impactile surfaces, in particular image or video walls, using the inexpensive technology of locating impacts by analysing time differences of propagation of progressive mechanical waves. This results in devices at least cost.

Note moreover that the invention is not limited to the embodiments described hereinabove. It will appear to those skilled in the art that various modifications can be made to the embodiments described hereinabove, in light of the teaching that has just been disclosed to them. In the claims that follow, the terms used must not be interpreted as limiting the claims to the embodiments disclosed in this description, but must be interpreted so as to include therein all of the equivalents that the claims aim to cover due to their formulation and of which the foreseeing is within the scope of those skilled in the art by applying their general knowledge to the implementing of the teaching that has just been disclosed to them.

1. A device for locating an impact against an interactive surface able to propagate progressive mechanical waves from the impact, comprising:
a set of M transducers arranged and distributed against the interactive surface, M≥4, designed to capture the progressive mechanical waves propagating in the interactive surface and to transform them into electrical signals, and
an electronic central unit, connected to the transducers in order to receive their electrical signals, programmed to locate the impact in the interactive surface by analysing time differences of propagation of progressive mechanical waves from the impact to the transducers on the basis of instants of impact detection identified in the electrical signals received,
characterised in that the electronic central unit is programmed for:
selecting, from the M transducers, a subset of N transducers, 3≤N<M, of which the electrical signals chronologically comprise the first N instants of detection of impact identified, and
locate the impact based on these N first instants of detection of impact identified and on the places of arrangement in the interactive surface of the N transducers selected.

2. The device for locating an impact according to claim 1, wherein the M transducers are distributed in a regular two-dimensional manner into a matrix of transducers against the interactive surface and the electronic central unit is programmed to select N=4, 6 or 9 transducers among these M transducers.

3. The device for locating an impact according to claim 1, wherein the M transducers are distributed in a regular two-dimensional manner staggered against the interactive surface and the electronic central unit is programmed to select N=3, 4 or 7 transducers among these M transducers.

4. The device for locating an impact according to claim 1, wherein:
the M transducers are electrically connected together into several separate groups which are themselves electrically connected to the electronic central unit,
at least three additional transducers are arranged and distributed against the interactive surface, designed to capture the progressive mechanical waves propagating in the interactive surface and to transform them into electrical signals transmitted independently to the electronic central unit, and
the electronic central unit is programmed to pre-locate the impact in the interactive surface based on the electrical signals received from the additional transducers and to select the subset of N transducers based on this pre-locating.

5. The device for locating an impact according to claim 2, wherein:
the M transducers are electrically connected together into four separate groups which are themselves electrically connected to the electronic central unit, in such a way that any four neighbouring transducers of the same basic cell of the matrix of transducers always belong respectively to the four separate groups, and
four additional transducers are arranged and distributed against the interactive surface.

6. The device for locating an impact according to claim 2, wherein:
the M transducers are electrically connected together into nine separate groups which are themselves electrically connected to the electronic central unit, in such a way that any nine neighbouring transducers forming four adjacent basic cells having the same common central transducer of the matrix of transducers always belong respectively to the nine separate groups, and
four additional transducers are arranged and distributed against the interactive surface.

7. The device for locating an impact according to claim 3, wherein:
the M transducers are electrically connected together into three separate groups which are themselves electrically connected to the electronic central unit, and
three additional transducers are arranged and distributed against the interactive surface.

8. The device for locating an impact according to claim 3, wherein:
the M transducers are electrically connected together into six separate groups which are themselves electrically connected to the electronic central unit, in such a way that any three neighbouring transducers of the same basic triangular cell of the matrix of transducers always belong respectively to three separate groups, and
three additional transducers are arranged and distributed against the interactive surface.

9. A method for locating an impact against an interactive surface able to propagate progressive mechanical waves from the impact, comprising the following steps:
capturing, using a set of M transducers arranged and distributed against the interactive surface, M≥4, the progressive mechanical waves propagating in the interactive surface and transforming them into electrical signals, and
locating the impact in the interactive surface, using an electronic central unit connected to the transducers in order to receive their electrical signals, by analysing time differences of propagation of progressive mechanical waves from the impact to the transducers on the basis of instants of impact detection identified in the electrical signals received,
characterised in that the locating of the impact comprises the following steps:
selecting, from the M transducers, a subset of N transducers, 3≤N<M, of which the electrical signals chronologically comprise the first N instants of detection of impact identified, and
locating the impact based on these N first instants of detection of impact identified and on the places of arrangement in the interactive surface of the N transducers selected.

10. A computer program that can be downloaded from a communication network and/or recorded on a support that can be read by a computer and/or executed by a processor, characterised in that it comprises instructions for the execution of the steps of a method for locating an impact according to claim 9, when said program is executed on a computer.
